(19) United States
(12) Patent Application Publication
(10) Pub. No.: US 2019/0187843 A1
(43) Pub. Date: Jun. 20, 2019

(54) FLEXIBLE TOUCH PANEL, TOUCH DISPLAY PANEL AND TOUCH DISPLAY DEVICE

(71) Applicant: Wuhan China Star Optoelectronics Semiconductor Display Technology Co., Ltd., Wuhan (CN)

(72) Inventor: Jian YE, Shenzhen (CN)

(21) Appl. No.: 16/016,789

(22) Filed: Jun. 25, 2018

Related U.S. Application Data
(63) Continuation of application No. PCT/CN2018/072621, filed on Jan. 15, 2018.

(30) Foreign Application Priority Data
Dec. 15, 2017 (CN) 201711353759.8

(51) Int. Cl. G06F 3/047

(52) U.S. Cl. CPC G06F 3/047; G06F 2203/04102; G06F 2203/04112

(57) ABSTRACT

The present application provides a flexible touch panel that is divided into at least two non-bending regions and a bending region that connects two adjacent non-bending regions. The flexible touch panel includes a metal mesh layer, the metal mesh layer includes a plurality of independent first touch electrode units patterned by a first metal mesh. The first touch electrode units are spaced apart from each other corresponding to the bending region, and the first metal mesh is a conductive line with a plurality of hollow patterns. The flexible touch panel can reduce the bending stress to be applied to the first touch electrode units when bending the bending region, so as to reduce the risk of the first metal mesh breaking when being bent. The present application further provides a touch display panel with a flexible touch panel and a touch display device with a flexible touch panel.

### RELATED APPLICATIONS

This application is a continuation application of PCT Patent Application No. PCT/CN2018/072621, filed Jan. 15, 2018, which claims the priority benefit of Chinese Patent Application No. CN 201711353759.8, filed Dec. 15, 2017, which is herein incorporated by reference in its entirety.

### FIELD OF THE DISCLOSURE

The present disclosure relates to a display panel, and more particularly to a flexible touch panel, a touch display panel with a flexible touch panel, and a touch display device with a flexible touch panel.

### BACKGROUND OF THE DISCLOSURE

A large number of electronic devices with touch functions are used in the public. In order to make the sensing elements transparent, electrodes are made of a transparent conductive material such as indium tin oxide (ITO), indium tin oxide (ITO). However, such materials have higher resistance values and are expensive to use. At this point, part of the touch panel adopts a mesh line to fabricate a touch sensing electrode, wherein the mesh line is formed by a mesh formed by periodically crossing extremely thin metal lines. However, for the foldable display which has the most potential applications at present, the existing touch panel with a mesh line is prone to rupture of the mesh line when bending, thereby affecting the touch effect of the touch panel.

### SUMMARY OF THE DISCLOSURE

In view of this, the present disclosure provides a flexible touch panel to effectively solve the above technical problem.

In addition, it is also necessary to provide a touch display having the above-mentioned flexible touch panel and a touch display having a flexible touch panel.

A flexible touch panel, which is divided into at least two non-bending regions and a bending region connecting adjacent two non-bending regions, the flexible touch panel includes a metal mesh layer with meshes, the metal mesh layer includes a plurality of independent first touch electrode units patterned by a first metal grid, the first touch electrode units are disposed corresponding to the bending zone, the first touch electrode units are spaced apart from each other, and the first metal mesh is formed by crossing conductive lines with a plurality of hollow patterns so as to form the mesh.

Further, a plurality of through holes are formed in the conductive lines so as to form the hollow patterns, and the through holes are distributed along an extending direction of the conductive lines.

Further, the conductive lines are at least one of a linear conductive line or a bent conductive line, and the bent conductive line is at least one of a wave-shaped conductive line and a zigzag-shaped conductive line.

Further, the metal grid layer further includes a plurality of independent second touch electrode units, the second touch electrode units are disposed corresponding to the non-bending regions, the second touch electrode units are spaced apart from each other, and the second touch electrode units are formed by patterning a second metal mesh.

Further, the second metal mesh is formed by crossing conductive lines with a plurality of hollow patterns.

Further, the flexible touch panel further includes a plurality of signal connection lines and at least one touch control chip, each of the signal connection lines is configured to electrically connect the corresponding first touch electrode units and the touch control chip.

Further, the flexible touch panel further includes a plurality of signal connection lines, each of the signal connection lines is electrically connected to the second touch electrode units and the touch control chip, and the first touch electrode units are virtual touch electrode units.

A touch display panel, including a display panel. The touch display panel further includes a flexible touch panel as described above, and the display panel and the flexible touch panel are stacked.

Further, the display panel includes R pixel, G pixel and B pixel, the alignment of the metal mesh layer avoids the R pixel, the G pixel and the B pixel such that the R pixel, the G pixel and the B pixel are located at meshes of the metal mesh layer.

A touch display device includes a display panel. The touch display device further includes a flexible touch panel as described above, and the display panel and the flexible touch panel are stacked.

Further, the display panel includes R pixel, G pixel and B pixel, the alignment of the metal mesh layer avoids the R pixel, the G pixel and the B pixel such that the R pixel, the G pixel and the B pixel are located at meshes of the metal mesh layer.

In the flexible touch panel of the present disclosure, the first touch electrode units corresponding to the bending region are patterned and formed by the first metal mesh formed by the conductive lines with the plurality of hollow patterns so that the bending stress to be borne by the first touch electrode units is reduced when the bending region is bent, so as to reduce the risk of the first metal mesh breaking when being bent.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a flexible touch panel according to the embodiment of the present disclosure.

FIG. 2 is a schematic structural diagram of a first metal grid according to the embodiment of the present disclosure.

FIG. 3 is a schematic structural diagram of a first metal grid according to another embodiment of the present disclosure.

FIG. 4 is a schematic structural diagram of a touch screen according to the embodiment of the present disclosure.

FIG. 5 is a partial cross-sectional view of a method of manufacturing a touch screen according to the embodiment of the present disclosure.

FIG. 6 is a schematic structural diagram of a touch display device according to the embodiment of the present disclosure.

### DETAILED DESCRIPTION OF PREFERRED EMBODIMENTS

The technical solutions in the embodiments of the present disclosure are clearly and completely described below with reference to the accompanying drawings in the embodiments of the present disclosure. Obviously, the described embodiments are only a part but not all of the embodiments of the present disclosure. All other embodiments obtained by persons of ordinary skill in the art based on the embodiments of the present disclosure without creative efforts shall fall within the protection scope of the present disclosure,

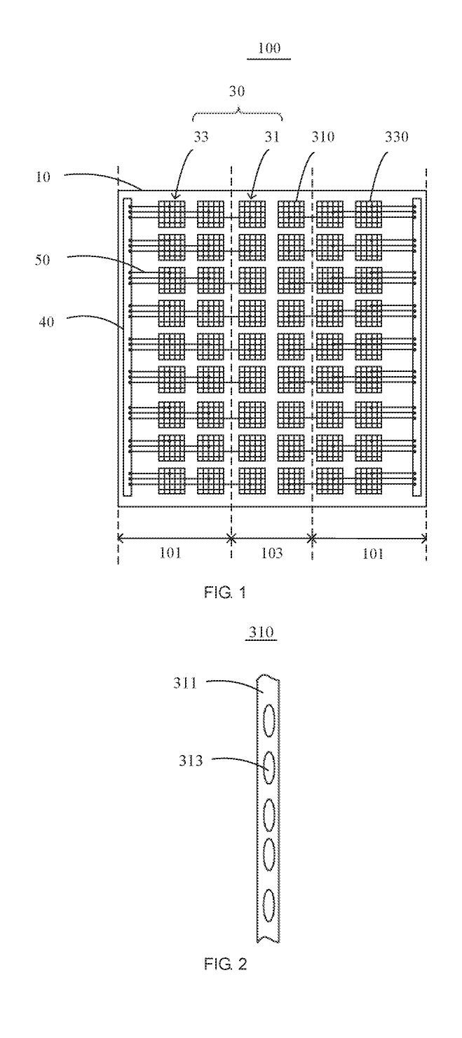

In the following, with reference to FIGS. 1 to 6 and the embodiments, the flexible touch panel 100, the touch panel 300 with the flexible touch panel 100, and the touch panel 200 with the flexible touch panel 100 provided by the technical solution will be further described in detail.

Please refer to FIG. 1 to FIG. 3, the flexible touch panel 100 according to a preferred embodiment of the present disclosure is configured to receive a touch operation of a user and detect a coordinate position of the touch operation, which is divided into at least two non-bending regions 101 and a bending region 103 connecting the two adjacent non-bending regions 101.

The flexible touch panel 100 includes a transparent flexible substrate 10 and a meshed metal mesh layer 30 formed on the transparent flexible substrate 10. The metal mesh layer 30 includes a plurality of first touch electrode units 31 and a plurality of second touch electrode units 33 distributed separately. The first touch electrode units 31 are disposed corresponding to the bending region 103, and the first touch electrode units 31 are spaced apart from each other. The second touch electrode units 33 are disposed corresponding to the non-bending regions 101, and the second touch electrode units 33 are spaced apart from each other.

Each first touch electrode units 31 is formed by patterning a first metal mesh 310. The first touch electrode units 31 may be at least one of a diamond, a square, a rectangle and the like. In the embodiment, the first touch electrode units 31 have a square shape. The first metal mesh 310 is formed by crossing conductive lines 311 with a plurality of hollow patterns so that the mesh is formed in the first metal mesh 310.

In the present embodiment, referring to FIG. 2, a plurality of through holes 313 are formed on the conductive lines 311 to form the hollow pattern. The through holes 313 are distributed in the middle region of the conductive line 311 along the extending direction of the conductive line 311. In other embodiments, the through hole 313 may be disposed away from a middle region of the conductive line 311.

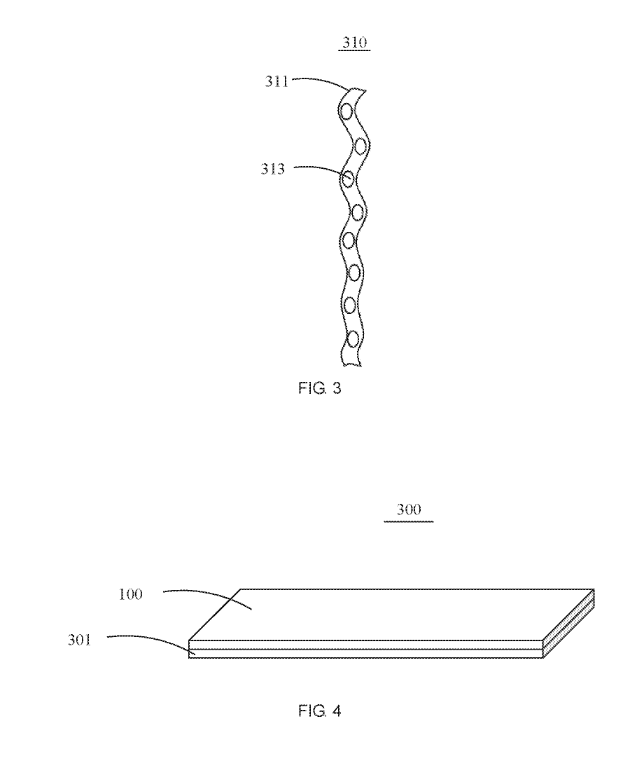

The conductive lines 311 may be linear conductive lines (see FIG. 2) or curved conductive lines (such as wave-shaped conductive lines and zigzag-shaped conductive lines) (see FIG. 3). The through hole 313 may be at least one of a circular hole, an oval hole, a prismatic hole or other shaped hole.

The second touch electrode units 33 are formed by patterning a second metal mesh 330. In the present embodiment, the second metal mesh 330 may also be formed by crossing conductive lines 311 with a plurality of hollow patterns. In other embodiments, the second metal mesh 330 is formed by crossing conductive lines without a hollow pattern, so that the mesh is formed in the second metal mesh 330.

Referring to FIG. 1, the flexible touch panel 100 further includes one or two touch control chips 40 and a plurality of signal connection lines 50. The first touch electrode units 31 and the second touch electrode units 33 are electrically connected to the touch chip 40 through the signal connection line 50, so that the touch control chip 40 receives the touch signal. When the flexible touch panel 100 includes one touch control chip 40, each of the first touch electrode units 31 and each of the second touch electrode units 33 are respectively electrically connected to the touch control chip 40 through a signal connection line 50. When the flexible touch panel 100 includes two touch control chips 40, the two touch control chips 40 are respectively located at a side of the two non-bending regions 101 away from the bending region 103, each second touch electrode units 33 and the touch control chip 40 located in the same non-bending region 101 with the second touch electrode units 33 are electrically connected through a signal connection line 50, the first touch electrode unit 31 is electrically connected to any touch control chip 40 through a signal connection line 50. In other embodiments, the number and the position of the touch control chip 40 are not limited.

In another embodiment, the first touch electrode units 31 are not electrically connected to the touch control chip 40 as a dummy touch electrode unit (I.e. floating electrode, Dummy) for adjusting the capacitance value and maintaining the visual consistency of the flexible touch panel 100. In addition, when the first touch electrode units 31 are not electrically connected to the touch control chip 40, even when the conductive lines 311 of the first touch electrode units 31 break during bending, the original touch effect of the flexible touch panel 100 is not affected.

Please also refer to FIG. 4 and FIG. 5, the touch display panel 300 includes the above-mentioned flexible touch panel 100 and a display panel 301 stacked with the flexible touch panel 100. The display panel 301 includes a plurality of light-emitting units 303 spaced apart from each other. The light-emitting unit 303 is selected from at least one of an R pixel, a G pixel, and a B pixel. In this embodiment, the display panel 301 includes an R pixel, a G pixel, and a B pixel,

The orthographic projections of the first touch electrode units 31 and the second touch electrode units 33 on the display panel 301 are located at the intervals between the light-emitting units 303 so as to prevent the first touch electrode units 31 and the second touch electrode units 33 from affecting the optical effect generated by the display panel 302. That is, the alignment of the metal mesh layer 30 avoids the R pixel, the G pixel and the B pixel so that the R pixel, the G pixel and the B pixel are located at the meshes of the metal mesh layer 30 so as to prevent the metal mesh layer 30 from affecting the optical effect generated by the display panel 302.

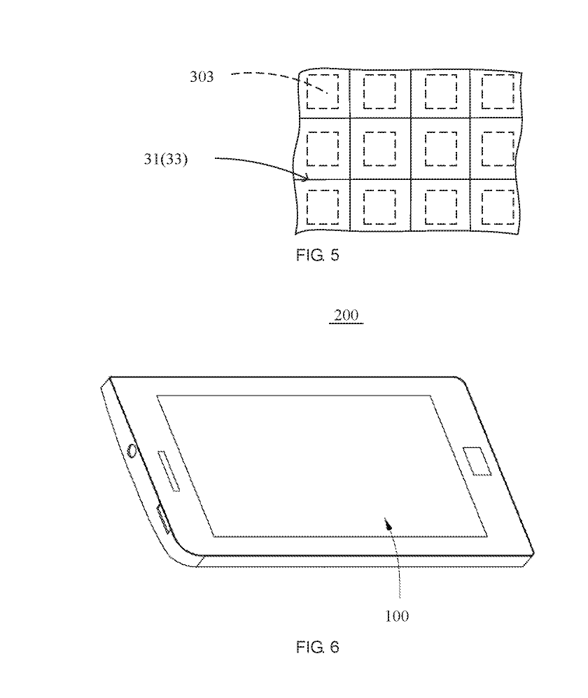

Please refer to FIG. 6, which is a schematic diagram of the touch display device 200, The touch display device 200 includes a flexible touch panel 100. The touch display device 200 may be a cell phone, a tablet, a television, or the like.

The touch display device 200 may further include a display panel 301 stacked on the flexible touch panel 100. The display panel 301 includes a plurality of light-emitting units 303 spaced apart from each other. The light-emitting unit 303 is selected from at least one of an R pixel, a G pixel, and a B pixel. The orthogonal projections of the first touch electrode unit 31 and the second touch electrode unit 33 on the display panel 301 are located at intervals of the light-emitting units 303. In this embodiment, the display panel 301 includes an R pixel, a G pixel, and a B pixel.

In the above-mentioned flexible touch panel 100 of the present disclosure, the first touch electrode units 31 corresponding to the bending regions 103 are patterned to form the first metal mesh 310 with conductive patterns with hollow patterns, so that the bending stress to be received by the first touch electrode unit 31 is reduced when the bending region 103 is bent, so as to reduce the risk of the first metal mesh 310 breaking when being bent, and the conductive lines 311 of the first metal mesh 310 are bent conductive lines (such as wave-shaped conductive lines and zigzag-shaped conductive lines), the risk of the first metal mesh 310 breaking when being bent may be further reduced.

The foregoing descriptions are merely preferred embodiments of the present disclosure and are not intended to limit the present disclosure in any form. Although the present disclosure has been disclosed in terms of the preferred embodiments, it is not intended to limit the present disclosure. Anyone skilled in the art may make some equivalent modifications or alterations to the equivalent embodiments without departing from the technical solution of the present disclosure by using the technical contents disclosed above. However, any simple modifications, equivalent changes and modifications made to the above embodiments according to the technical essence of the present disclosure all fall within the scope of the technical solutions of the present disclosure without departing from the contents of the technical solutions of the present disclosure.

1. A flexible touch panel, wherein the flexible touch panel is divided into at least two non-bending regions and a bending region connecting adjacent two non-bending regions, the flexible touch panel comprises a metal mesh layer with meshes, the metal mesh layer comprises a plurality of independent first touch electrode units patterned by a first metal grid, the first touch electrode units are disposed corresponding to the bending region, the first touch electrode units are spaced apart from each other, and the first metal mesh is formed by crossing conductive lines with a plurality of hollow patterns so as to form the mesh.

2. The flexible touch panel according to claim 1, wherein a plurality of through holes are formed in the conductive lines so as to form the hollow patterns, and the through holes are distributed along an extending direction of the conductive lines.

3. The flexible touch panel according to claim 2, wherein the conductive lines are at least one of a linear conductive line or a bent conductive line, and the bent conductive line is at least one of a wave-shaped conductive line and a zigzag-shaped conductive line.

4. The flexible touch panel according to claim 1, wherein the metal grid layer further comprises a plurality of independent second touch electrode units, the second touch electrode units are disposed corresponding to the non-bending regions, the second touch electrode units are spaced apart from each other, and the second touch electrode units are formed by patterning a second metal mesh.

5. The flexible touch panel according to claim 4, wherein the second metal mesh is formed by crossing conductive lines with a plurality of hollow patterns.

6. The flexible touch panel according to claim 1, wherein the flexible touch panel further comprises a plurality of signal connection lines and at least one touch control chip, each of the signal connection lines is configured to electrically connect the corresponding first touch electrode units and the touch control chip.

7. The flexible touch panel according to claim 4, wherein the flexible touch panel further comprises a plurality of signal connection lines, each of the signal connection lines is electrically connected to the second touch electrode units and the touch control chip, and the first touch electrode units are virtual touch electrode units.

8. A touch display panel, comprising a display panel and a flexible touch panel, wherein the display panel and the flexible touch panel are stacked, the flexible touch panel is divided into at least two non-bending regions and a bending region connecting adjacent two non-bending regions, the flexible touch panel comprises a metal mesh layer with meshes, the metal mesh layer comprises a plurality of independent first touch electrode units patterned by a first metal grid, the first touch electrode units are disposed corresponding to the bending region, the first touch electrode units are spaced apart from each other, and the first metal mesh is formed by crossing conductive lines with a plurality of hollow patterns so as to form the mesh.

9. The touch display panel according to claim 8, wherein a plurality of through holes are formed in the conductive lines so as to form the hollow patterns, and the through holes are distributed along an extending direction of the conductive lines,

10. The touch display panel according to claim 9, wherein the conductive lines are at least one of a linear conductive line or a bent conductive line, and the bent conductive line is at least one of a wave-shaped conductive line and a zigzag-shaped conductive line.

11. The touch display panel according to claim 8, wherein the metal grid layer further comprises a plurality of independent second touch electrode units, the second touch electrode units are disposed corresponding to the non-bending regions, the second touch electrode units are spaced apart from each other, and the second touch electrode units are formed by patterning a second metal mesh.

12. The touch display panel according to claim 11, wherein the second metal mesh is formed by crossing conductive lines with a plurality of hollow patterns.

13. The touch display panel according to claim 8, wherein the flexible touch panel further comprises a plurality of signal connection lines and at least one touch control chip, each of the signal connection lines is configured to electrically connect the corresponding first touch electrode units and the touch control chip.

14. The touch display panel according to claim 11, wherein the flexible touch panel further comprises a plurality of signal connection lines, each of the signal connection lines is electrically connected to the second touch electrode units and the touch control chip, and the first touch electrode units are virtual touch electrode units.

15. The touch display panel according to claim 8, wherein the display panel comprises R pixel, G pixel and B pixel, an alignment of the metal mesh layer avoids the R pixel, the G pixel and the B pixel such that the R pixel, the G pixel and the B pixel are located at meshes of the metal mesh layer.

16. A touch display device, comprising a display panel and a flexible touch panel, wherein the display panel and the flexible touch panel are stacked, the flexible touch panel is divided into at least two non-bending regions and a bending region connecting adjacent two non-bending regions, the flexible touch panel comprises a metal mesh layer with meshes, the metal mesh layer comprises a plurality of independent first touch electrode units patterned by a first metal grid, the first touch electrode units are disposed corresponding to the bending region, the first touch electrode units are spaced apart from each other, and the first metal mesh is formed by crossing conductive lines with a plurality of hollow patterns so as to form the mesh.

17. The touch display device according to claim 16, wherein a plurality of through holes are formed in the conductive lines so as to form the hollow patterns, and the through holes are distributed along an extending direction of the conductive lines.

18. The touch display device according to claim 17, wherein the conductive lines are at least one of a linear conductive line or a bent conductive line, and the bent conductive line is at least one of a wave-shaped conductive line and a zigzag-shaped conductive line.

19. The touch display device according to claim 16, wherein the metal grid layer further comprises a plurality of independent second touch electrode units, the second touch electrode units are disposed corresponding to the non-bending regions, the second touch electrode units are spaced apart from each other, and the second touch electrode units are formed by patterning a second metal mesh.

20. The touch display device according to claim 19, wherein the second metal mesh is formed by crossing conductive lines with a plurality of hollow patterns.
